(19) United States
(12) Patent Application Publication
(10) Pub. No.: US 2006/0157266 A1
(43) Pub. Date: Jul. 20, 2006

(54) Earthing device for cables with outer jacket

(75) Inventors: Erhard Mahlandt, Laatzen (DE); Otto Schumacher, Heisede (DE); Michael Stansbie, Wedemark (DE); Gerhard Wunder, Langenhagen (DE); Reimer Nagel, Hannover (DE); Thomas Horn, Hannover (DE); Fredy Ahlenstorf, Nienburg/W (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/319,655

(22) Filed: Dec. 29, 2005

(30) Foreign Application Priority Data
Jan. 19, 2005 (EP) 05290116.2

(51) Int. Cl. H02G 15/08

(52) U.S. Cl. 174/78

(57) ABSTRACT

A ground connector for earthing a cable having an outer jacket closely surrounding an inner conductor, the ground connector comprising a connector body, with at least one contact element for providing electrical contact between the connector body and the inner conductor of the cable, and at least one opening element so designed to cut and/or perforate the outer jacket. A method for earthing a cable with such a ground connector.

### BACKGROUND OF THE INVENTION

The invention is based on a priority application EP 05290116.2 which is hereby incorporated by reference.

The invention relates to a ground connector for earthing a cable, in particular a coaxial cable, wherein the cable has an outer jacket closely surrounding an inner conductor, the ground connector comprising a connector body, in particular a sleeve-type connector body, with at least one contact element for providing electrical contact between the connector body and the inner conductor of the cable.

A ground connector of such a type is disclosed in WO 02/03501 A1. Radio frequency (=RF) cables are used in numerous applications, e.g. in mobile radio telephone service, broadcasting service or beam radio. In particular, antennas are connected with receivers (such as a TV set) and transmitters via RF cables.

In order to protect users and buildings, it is necessary to ground these cables.

The cables have a protective, electrically insulating outer jacket, typically made of plastic or rubber. This outer jacket closely surrounds an inner conductor made of metal, such as copper, but the outer jacket typically is not glued onto the inner conductor. The inner conductor is typically of tubular shape and houses a central conductor which is embedded in a dielectric.

Grounding the cable, i.e. installation of a ground connector, is a two step procedure in the state of the art. First, the outer jacket is removed at a defined length. This removal is accomplished by means of special tools or a simple knife in manual operation. Second, after the inner conductor has been uncovered, the known ground connector is attached to the cable, and contact is established between the uncovered inner conductor and the ground connector.

The first step of this known procedure, i.e. the removal of the outer jacket, is a rather time consuming step. The tools, which may be expensive in acquisition, must be provided for every grounding operation. Further, the metallic inner connector may be damaged at the removal of the outer jacket with a knife.

### OBJECT OF THE INVENTION

It is the object of the present invention to provide a ground connector which is easier to install than known ground connectors.

This object is achieved, by means of the invention, by a ground connector of the type mentioned in the beginning, characterized in that the ground connector comprises at least one opening element so designed to cut and/or perforate the outer jacket.

The basic idea of the invention is to save the first step of the installation procedure of known ground connectors. With the inventive ground connector, the installation is reduced to a one step procedure. The inventive ground connector is attached directly to the cable, without prior removal of the outer jacket. The inventive ground connector provides at least one opening element, such as a cutting edge, blade or a thorn, which cuts or perforates the outer jacket upon installation of the ground connector. The opening thus created allows the at least one contact element to access to the inner conductor. A special tool or a knife for removing the outer jacket are unnecessary. By means of the invention, a simple, cost-efficient, fast and safe grounding of a cable is achieved.

When installed, in accordance with the invention, the contact area between the inner conductor and the contact element(s) is sufficiently large and the DC resistance between ground connector and cable is sufficiently low to fulfil the standards of lightning protection.

The connector body is partly or entirely made of electrically conductive material, in particular a metal such as copper or stainless steel. The connector body may also be made of plastic coated with metal. The connector body has junction to a ground wire.

The stiffness and strength of the opening element(s) and contact element(s) is advantageously chosen such that the outer jacket can be penetrated reliably, but the inner conductor cannot be damaged.

The inventive ground connector, i. e. the inventive device for grounding a cable, may be installed equally well at an end of a cable, or at a midway section of the cable, because it is attached directly to the outer jacket.

The ground connector may comprise a shell type connector body so that it can clasp around the cable. For this purpose, the connector body has a shape at its inside substantially corresponding to the outer shape of the cable to be grounded. Preferably, the shell type connector body has an opening at one side for imposing the ground connector on the cable at a midway section. At both sides of the opening, a tab (or ear) is provided. By putting the tabs closer together, e.g. by turning a screw held in an opening and a thread of the respective tabs, the connector body can be tightened around the cable. This guarantees a safe fastening of the ground connector. The cable is preferably of circular shape, such as a standard coaxial cable. However, the cable may also have other shapes, i.e. cross sections, such as a rectangular shape. The sleeve-type connector body may be made of one elastically deformable part or of two half shells connected by a joint, for example.

The inventive ground connector can be provided with sealings, and in particular with a waterproof shell body, for preventing the intrusion of humidity to the contact area. Then the ground connector is suitable for outdoor applications.

The typical kind of cable to be contacted is an RF cable, in particular a coaxial cable with a round cross section. However, all types of RF cables are suitable for use with the invention.

Preferably, there are several opening elements and several contact elements. The opening elements and the contact elements are typically evenly distributed on the connector body. Advantageously, the contact elements are arranged pairwise opposite to each other, what guarantees a constant contact pressure. However, other means for providing a constant contact pressure of the contact elements can be used. A similar arrangement is advantageous for the opening elements in order to achieve a uniform cutting or perforation of the outer jacket.

In a preferred embodiment of the inventive ground connector, the at least one opening element and the at least one contact element are identical parts of the ground connector. The at least one opening element serves as a contact element, too, and there is no separate contact element apart from the at least one multifunctional opening element. There may be one multifunctional opening element or several multifunctional opening elements. This embodiment simplifies the design of the inventive ground connector. However, in the alternative case also covered by the invention, when the opening element(s) and contact element(s) are separate parts, each element can be more specialized to its function.

A highly preferred embodiment of the inventive ground connector is characterized in that the ground connector comprises a sleeve-type connector body, that the at least one opening element is positioned at the inside of the connector body, and that the at least one opening element comprises a blade inclined with respect to the radial direction of the connector body. A corresponding embodiment will be discussed with reference to FIG. 1a, 1b. The blades can cut the outer jacket of the cable. This embodiment is easy to manufacture. Preferably, the connector body is made of a sheet metal, and the blade or blades are manufactured by stamping the sheet metal. The radial direction is defined by the normal with respect to the local face of the inside of the connector body where the blade is fixed to the connector body. Typically, the cable and the connector body have an annular cross-section in this embodiment, the radial direction is directed towards the center of the connector body (or, in the mounted state, towards the center axis of the cable), and the cutting edges of the blades are in parallel with a center axis if the cable. Typical angles of the blade with respect to the radial direction are 25° through 50°. Through a twisting movement of the connector body around the cable, the blades carve with their cutting edges into the outer jacket. In case of non-annular shapes, a shifting movement of the connector body along the cable may replace the twisting movement. The extension of the blades in the radial direction preferably corresponds to the thickness of the outer jacket of the cable in order to protect the inner conductor during installation of the inventive ground connector.

A further development of this embodiment is characterized in that the at least one contact element is positioned at the inside of the connector body, that the contact element protrudes radially inwards with respect to the connector body, that the contact element can be moved towards the inside face of the connector body by elastic deformation. A corresponding design will be discussed with reference to FIG. 4a, 4b. In this embodiment, the blades peel off the outer jacket from the inner conductor, and the contact element or contact elements bear on the inner conductor. In that position, the inner conductor elastically deforms the contact elements, i.e. the inner conductor pushes the contact elements radially outwards towards the inside of the connector body, resulting in an elastic contact pressure of the contact elements on the inner conductor. This design guarantees good electrical contact.

A further development of the former further development is characterized in that the ground connector comprises only one opening element, that the ground connector further comprises an annular shell body surrounding the connector body, but leaving an annular gap between the outside face of the connector body and the shell body for housing detached material of the outer jacket, and that the contact element is elastically pre-stressed radially inwards by a spring element. A corresponding design will be discussed with reference to FIG. 5a, 5b. This design allows the peeling off of the outer jacket at one piece. The peeled-off outer jacket can be stored in the annular gap. The spring element, in particular comprising a leaf spring, increases the contact pressure of the contact element or the contact elements to the inner connector.

Another advantageous embodiment of the inventive ground connector is characterized in that the ground connector comprises an annular connector body and an annular shell body surrounding the connector body, that the shell body is twistable against the connector body, that the at least one opening element is movable in a radial direction, that the opening element has an inclined outer face, that the shell body comprises at least one recess for housing the at least one opening element in a radially outer position, and that the opening element has a cutting edge at its radially inner side. A corresponding embodiment will be discussed with reference to FIG. 2a, 2b. Upon activation of the ground connector, i.e. a twist of the connector body with respect to the shell body, the movable opening element is forced to move radially inwards towards the cable, i.e. from the outer position into a perforating position. The cutting edge carves through the outer jacket. In this embodiment, the movable opening element or elements preferably serve as contact elements, too. Then the twisted (or activated) position of connector body and shell body also provides a high contact pressure and thus a good electrical contact between inner conductor and the movable opening elements. Alternative to an inclined outer face of the movable opening element, and in accordance with the invention, an inclined inner face of the recess of the shell body may force the movable opening element radially inwards upon activation. Preferably, both the movable opening element and the recess have inclined faces for better stability.

Another preferred embodiment of the invention is characterized in that the ground connector comprises a sleeve-type connector body, that the at least one opening element is positioned at the inside of the connector body, and that the at least one opening element comprises a cutting edge or a needlepoint directed inwards in the radial direction of the connector body. A corresponding embodiment will be discussed with reference to FIG. 3a, 3b. This embodiment is extremely simple to manufacture and to install. The cutting edges or needle points pierce the outer jacket upon activation and contact the inner conductor as contact elements. Again, the extension of the opening elements preferably corresponds to the thickness of the outer jacket of the cable to be grounded in order to protect the inner conductor.

The invention also comprises a method for earthing a cable, in particular a coaxial cable, wherein the cable has an outer jacket surrounding an inner conductor, characterized in that

a) an inventive ground connector is collocated over the outer jacket of the cable,

b) that the ground connector is activated, in particular by a rotational movement of the connector body and/or by applying a radial pressure to the connector body, such that the at least one opening element cuts and/or perforates the outer jacket and the at least one contact element contacts the inner conductor.

In the state of the art, a ground connector is installed in a two step procedure, see above. In particular, the ground connector of the state of the art is collocated over an uncovered part of the inner conductor of the cable. The inventive method simplifies this procedure by omitting the first step of removal of the outer jacket prior to attachment of the ground connector. By means of the invention, the outer jacket is cut or perforated when the ground connector is already attached to the cable to be grounded. The inventive ground connector itself provides means for this purpose. Upon activation, in particular rotation, exerting pressure of shifting the ground connector with respect to the cable, the outer jacket is opened and direct contact between the inner conductor of the cable and the connector body, i.e. its connecting element or elements, is established.

In a preferred variant of the inventive method, a suitable inventive ground connector is activated by rotating the connector body in the direction where the blade of the at least one opening element is pointing towards. The cutting edge of the blade is then forced into the outer jacket of the cable. It may be useful to exert radial pressure together with the rotational movement in order to lead the cutting edge deeper into the outer jacket. The rotational movement is easy to perform and can be accomplished even by untrained personnel. This variant is useful with annular (i.e. circular) shaped connector bodies and opening elements comprising an inclined blade at its inside.

In another preferred variant of the inventive method, a suitable inventive ground connector is activated by rotating the shell body against the connector body in the direction in which the stretch of the movable opening element in the radial direction increases. The rotation forces the movable opening element into the outer jacket and onto the inner conductor of the cable. The rotational movement is easy to perform and can be accomplished even by untrained personnel. This method is useful with ground connectors comprising opening elements movable in a radial direction.

In an advantageous variant of the inventive method for use with a suitable inventive ground connector, the ground connector is activated by applying radial pressure to the connector body, in particular by pressing together two tabs of the sleeve-type connector body. Pressing together two tabs, e.g. by turning a screw, is extremely easy to perform and can be accomplished even by untrained personnel.

Further advantages can be extracted from the description and the enclosed drawing. The features mentioned above and below can be used in accordance with the invention either individually or collectively in any combination. The embodiments mentioned are not to be understood as exhaustive enumeration but rather have exemplary character for the description of the invention.

### BRIEF DESCRIPTION OF THE DRAWINGS

The invention is shown in the drawings.

FIG. 1a shows an inventive ground connector attached to a cable before activation, wherein the connector body comprises seven blade-shaped opening elements at its inside.

FIG. 1b shows the ground connector of FIG. 1a in an activated state.

FIG. 2a shows parts of an inventive ground connector attached to a cable before activation, wherein the connector body comprises a radially movable opening element.

FIG. 2b shows the ground connector of FIG. 2a in an activated state.

FIG. 3a shows an inventive ground connector attached to a cable before activation, wherein the connector body comprises seven thorn-shaped opening elements.

FIG. 3b shows the ground connector of FIG. 3a in an activated state.

FIG. 4a shows parts of an inventive ground connector attached to a cable before activation, wherein the connector body comprises a blade shaped opening element and a separate contact element.

FIG. 4b shows the ground connector of FIG. 4a in an activated state.

FIG. 5a shows an inventive ground connector attached to a cable before activation, wherein the connector body comprises one blade shaped opening element and a separate contact element supported by a leaf spring.

FIG. 5b shows the ground connector of FIG. 5a in an activated state, wherein the peeled-off outer jacket is stored in an annular gap.

FIG. 6 shows the cross section of a typical coaxial cable of the state of the art for use with the invention.

### DETAILED DESCRIPTION OF THE DRAWINGS

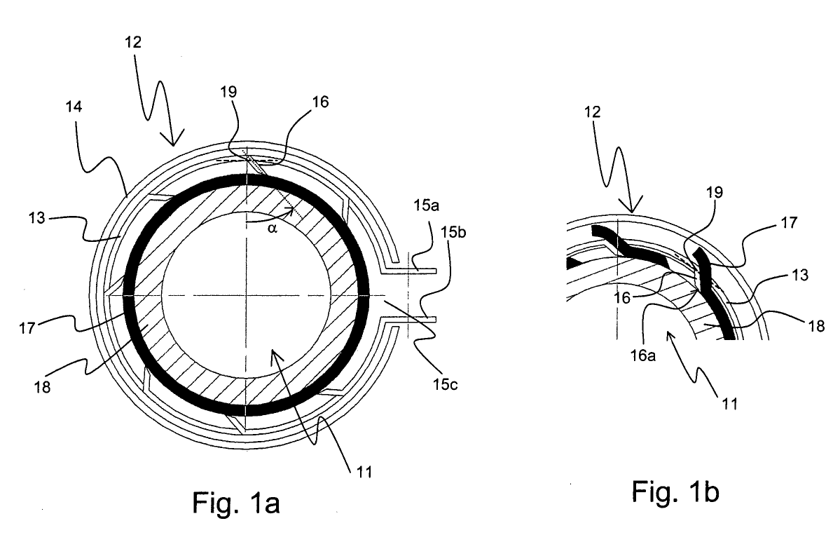

FIG. 1a shows a cable 11 and an inventive ground connector 12 clasping around the cable 11 before activation of the ground connector 12 in a schematic cross-sectional view perpendicular to the extension of the cable 11.

The ground connector 12 comprises a connector body 13. The connector body 13 is circular (or annular) in shape. The connector body 13 is surrounded by a shell body 14. The connector body 13 has an opening 15c at one side, which is limited by two tabs (or ears) 15a, 15b. The connector body 13 further comprises several opening elements 16 in the shape of a blade. Each blade has a cutting edge at its end.

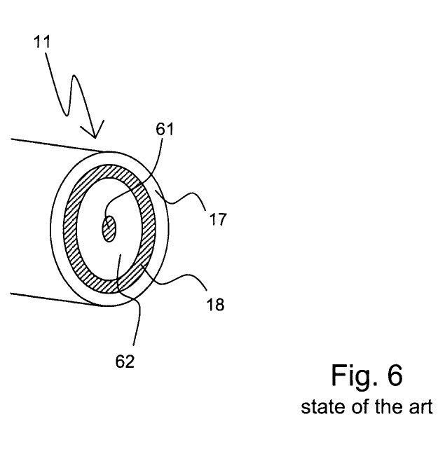

The cable 11 comprises an outer jacket 17, typically made of plastic, and an inner conductor 18, typically made of metal. The outer jacket 17 is situated directly on the inner conductor 18, but it is not glued onto the inner conductor 18. In FIG. 1a the inner structure of the cable 11 inside the inner conductor 18 is not shown for simplification (compare FIG. 6 for details).

The blades direct at the outer jacket 17 at an angle [symbol] with respect to the radial direction which is perpendicular to the local inside face 19 of the connector body 13 where the blade is fixed to the connector body 13.

In order to activate the ground connector 12, the connector body 13 is rotated into the direction where the blades generally point towards, i.e. clockwise. At the same time, the tabs 15a, 15b are pressed together in order to decrease the effective radius of the annular connector body 13. FIG. 1b shows part of the ground connector 12 and the cable 11 in an activated state. The opening elements 16 have carved into the outer jacket 17 and peeled off some of the outer jacket material. In front of each blade, the connector body 13 has openings broad enough to let the peeled off material move through; sufficient openings are automatically created when manufacturing the blades by stamping from a sheet metal connector body. In the activated state, each opening element 16 contacts the inner conductor 18 with a flat face 16a facing towards the inner conductor 18 and adjacent to the cutting edge of the opening element 16. The flat face 16a is roughly parallel to the corresponding local inside face 19 of the connector body 13; tolerances may be balanced by elastic deformation of the opening elements 16, if necessary. Thus in the embodiment of FIG. 1a, 1b, the opening elements 16 also act as contact elements.

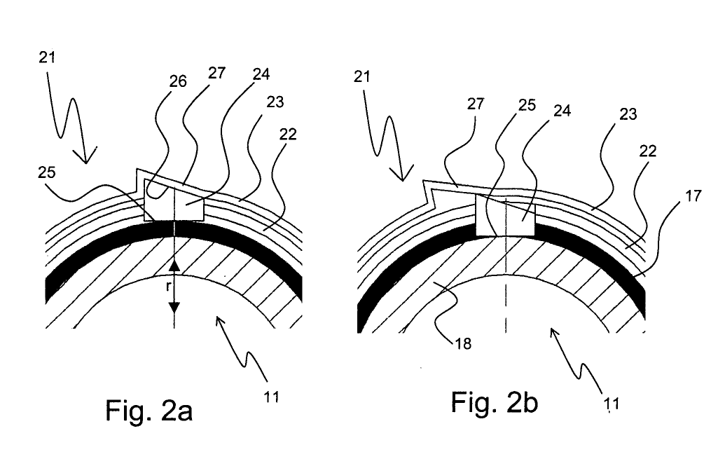

FIG. 2a shows parts of a cable 11 and an inventive ground connector 21, both of circular shape, before activation. The ground connector 21 comprises a connector body 22 and a shell body 23. The connector body 22 comprises an opening element 24 which is movable in a radial direction r and guided by the connector body 22. At its inner side, the opening element 24 has a cutting edge 25, whereas an outer face 26 of the opening element 24 is inclined with respect to the local circumferential direction of the connector body 22. The shell body 23 has a recess 27 for housing the opening element 24 in the non-activated state, i.e. when the opening element 24 is in a radially outer position. The shape of the recess 27 corresponds to the shape of the outer face 26 of the opening element 24.

In order to activate the ground connector 21, i.e. for establishing an electrical contact between the connector body 22 and the inner conductor 18 of the cable 11, the shell body 23 is rotated against the connector body 22. The rotation direction of the shell body 23 with respect to the connector body 22 is towards the direction in which the radial extension of the opening element 24 or of the recess 27, respectively, increases, here counterclockwise. The resultant state is shown in FIG. 2b. When the shell body 23 and the recess 27 rotate away from the opening element 24, the space for housing the opening element 24 vanishes. The opening element 24 has to move radially inwards, i.e. through the outer jacket 17 and towards the inner conductor 18. The cutting edge 25 cuts the outer jacket 17 of the cable 11. In the activated state, the cutting edge 25 of the opening element 24 is pressed upon the inner conductor 18, establishing an electrical contact between the inner conductor 18 and the connector body 22. Again, the opening element 24 in FIG. 2a, 2b acts as a contact element.

It may be useful to fix the position of the connector body 22 with respect to the cable 11 during the activation of the ground connector 21, i.e. during rotation of the shell body 23. For this purpose, the connector body 22 may comprise fixing means such as a catch at the inside of the connector body 22.

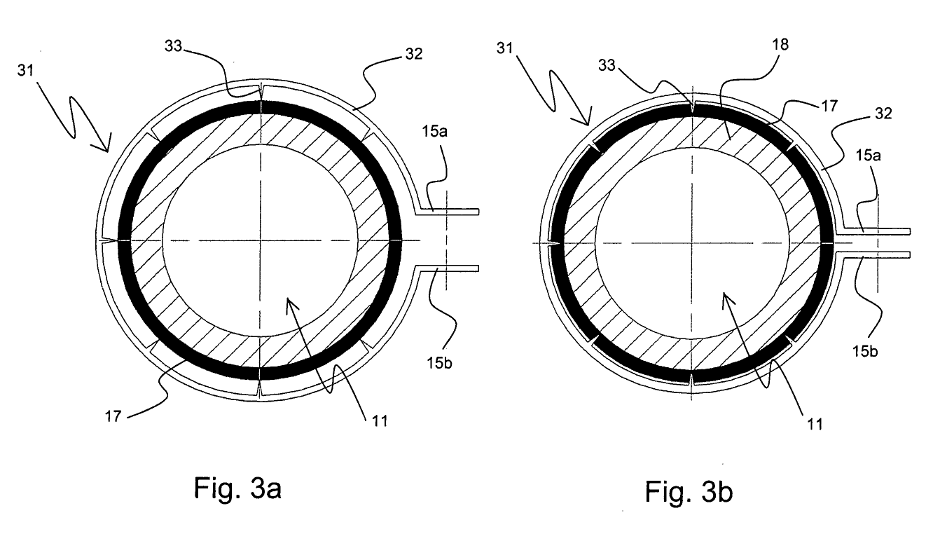

FIG. 3a shows schematically a cable 11 and another inventive ground connector 31 with a shell-type connector body 32 before activation. The connector body 32 comprises several opening elements 33 which narrow towards their ends where they have cutting edges. These cutting edges extend perpendicular to the plane of the drawing, i.e. in parallel to the extension of the cable 11, so they give a thorn-like cross-section in FIG. 3a. The cutting edges are directed perpendicularly away from the local inside face of the connector body 32. In other words, they are directed towards the center of the cable 11, i.e. radially inwards.

When exerting a radial pressure onto the connector body 32, in particular by pressing together two tabs 15a, 15b of the connector body 32, the cutting edges perforate the outer jacket 17 of the cable 11. In the activated state, the cutting edges and thus the opening elements 33 touch the inner conductor 18, see FIG. 3b. So again, the opening elements 33 serve as contact elements in this embodiment of the invention. In order to protect the inner conductor 18 from damages by the cutting edges, the tabs 15a, 15b may have a mechanical stop in order to maintain a minimum distance from each other and thus a minimum radius of the connector body 32.

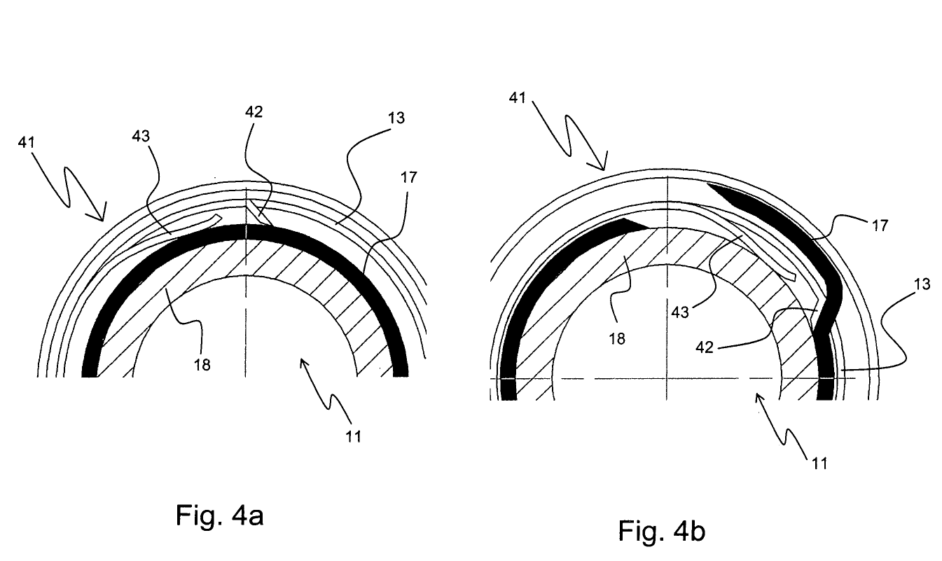

FIG. 4a shows parts of an improved inventive ground connector 41 based on the embodiment of FIG. 1a, 1b, together with a cable 11 to be contacted, before activation. At the inside of the connector body 13, for each opening element 42 (comparable to the opening elements 16 of FIG. 1a, 1b), a separate contact element 43 is provided. With respect to the clockwise direction of rotation of the connector body 13 for activation, the contact element 43 is located behind the opening element 42. The contact element 43 protrudes radially inwards towards the center of the connector body 13 or the center of the cable 11, but it is elastically flexible in the radial direction.

When the opening element 42 has peeled off enough material of the outer jacket 17, the contact element 43 glides onto the free surface of the inner conductor 18 upon activation. FIG. 4b shows such an activated state. The contact area between inner conductor 18 and connector body 13 is increased, compared with a contact established by the opening elements 42 alone as in FIG. 1a, 1b. Due to its elastic behavior, the contact element 43 touches the inner conductor 18 with some contact pressure, in particular more contact pressure than the opening elements 42. Thus the electrical contact as a whole is improved. Note that the contact pressure of the opening element 42 may be limited with respect to the danger of damaging the inner conductor 18 with the cutting edge at the tip of the opening element 42.

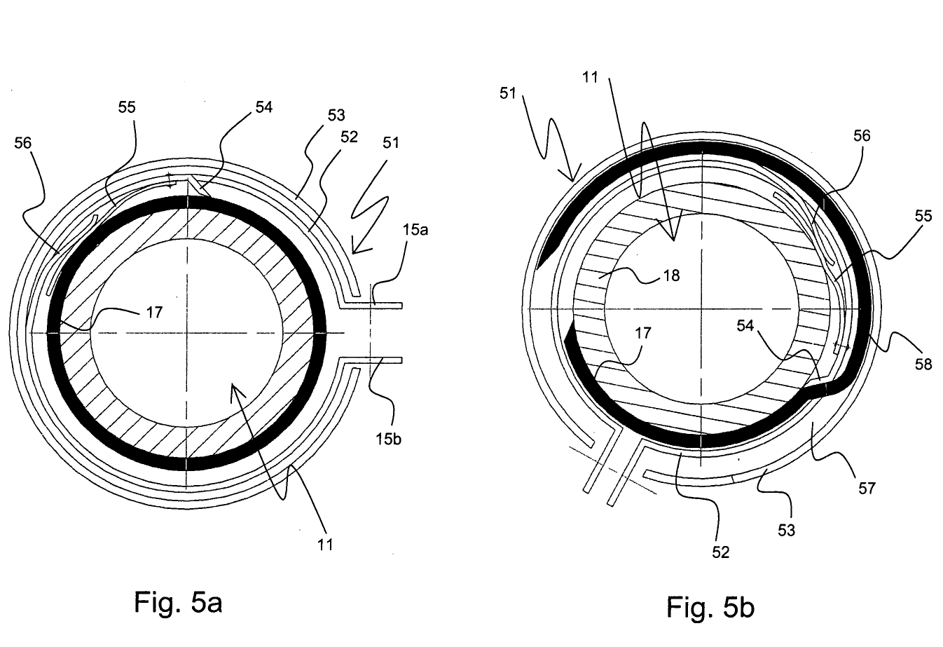

The embodiment of FIG. 5a is based on the embodiments of FIG. 1a, 1b, 4a, 4b. An inventive ground connector 51 surrounds a cable 11 to be grounded. The ground connector comprises a connector body 52 and a shell body 53, both annular in shape. The connector body 52 comprises two tabs 15a, 15b, one opening element 54 (comparable to the opening element 16 in FIG. 1a), one contact element 55 and a spring element 56. The spring element 56 presses the contact element 55 radially inward, so that the contact element 55 rests on the outer jacket 17 of the cable 11 with a significant contact pressure.

The ground connector 51 is activated by rotating the connector body 52 clockwise with respect to the cable 11, and concurrently tightening the connector body 52 (i.e. exerting radial pressure). FIG. 5b shows the activated state, after about a 120° rotation of the connector body 52. The opening element 54 has cut the outer jacket 17 and removed it partially from the inner conductor 18. In the tightened state of the connector body 52, there is an annular gap 57 between the connector body 52 and the shell body 53 wide enough to receive the outer jacket material 58 which has been peeled off by the opening element 54. In front of the opening element 42, the connector body 52 has an opening large enough to let the outer jacket material 58 pass. The contact element 55 is now pressed onto the uncovered inner conductor 18 of the cable 11 by the spring element 56, so good electrical contact is established. With the spring element 56, a defined (and in particular a high) contact pressure can be chosen. The contact element 55 has a section with a radius of curvature corresponding to the radius of curvature of the inner conductor, so a large contact area can be used. The contact element 55 may be designed as a braid of copper.

In an embodiment not shown in the figures, an inventive ground connector comprises a connector body with at least one opening element designed like a fork. The prongs of the at least one opening element pierce the outer jacket and contact the inner conductor of the cable. The prongs have flattened sections adjusted for contacting the inner conductor, preferably tangentially.

FIG. 6 shows the end of a typical coaxial cable 11 of the state of the art in a schematic view. Such a coaxial cable 11 can be grounded with an inventive ground connector as shown in FIGS. 1a through 5b at a midway section of the cable 11.

The coaxial cable 11 has an outer jacket 17 made of plastic which closely surrounds an inner conductor 18. The inner conductor 18 is typically made of solid metal or a metallic braid (woven from metallic threads) for high flexibility. Inside of this tube-like inner conductor 18, there is a central conductor 61 made of metal, typically of tubular shape or a wire. Between the inner conductor 18 and the central conductor 61, a dielectric material 62 is provided. Sometimes the dielectric is replaced by spacers (and air). Typically, the dimensions of the inner conductor 18 and the central conductor 61 as well as the characteristics of the dielectric material 62 are chosen such that a defined wave resistance of the coaxial cable 11, such as 50 Ohm for example, is obtained.

The invention provides a device for grounding an RF cable in particular at a midway section. The device (or ground connector) is attached to the cable without preparing the cable in any way, in particular the cable still has its outer jacket (or external jacket) then. The ground connector has built in mechanical means for uncovering an inner conductor (or internal conductor) of the cable which are called opening element(s). Further, the device has built in mechanical means for establishing an electrical contact between the ground connector and the inner conductor of the cable which are called contact element(s). The means for uncovering the inner conductor and the means for establishing the electrical contact may be identical in order to simplify the ground connector. The uncovering of the inner conductor is performed automatically when installing the ground connector, thus saving time, effort and costs at earthing the RF cable.

1. A ground connector for earthing a cable, in particular a coaxial cable, wherein the cable has an outer jacket closely surrounding an inner conductor,
the ground connector comprising a connector body, in particular a sleeve-type connector body, with at least one contact element for providing electrical contact between the connector body and the inner conductor of the cable, wherein
the ground connector comprises at least one opening element so designed to cut and/or perforate the outer jacket.

2. The ground connector according to claim 1, characterized in that the at least one opening element and the at least one contact element are identical parts of the ground connector.

3. The ground connector according to claim 1, characterized in that the ground connector comprises a sleeve-type connector body, that the at least one opening element is positioned at the inside of the connector body, and that the at least one opening element comprises a blade inclined with respect to the radial direction of the connector body.

4. The ground connector according to claim 3, characterized in that the at least one contact element is positioned at the inside of the connector body, that the contact element protrudes radially inwards with respect to the connector body, that the contact element can be moved towards the inside face of the connector body by elastic deformation.

5. The ground connector according to claim 4, characterized in that the ground connector comprises only one opening element, that the ground connector further comprises an annular shell body surrounding the connector body, but leaving an annular gap between the outside face of the connector body and the shell body for housing detached material of the outer jacket, and that the contact element is elastically pre-stressed radially inwards by a spring element.

6. The ground connector according to claim 1, characterized in that the ground connector comprises an annular connector body and an annular shell body surrounding the connector body, that the shell body is twistable against the connector body, that the at least one opening element is movable in a radial direction, that the opening element has an inclined outer face, that the shell body comprises at least one recess for housing the at least one opening element in a radially outer position, and that the opening element has a cutting edge at its radially inner side.

7. The ground connector according to claim 1, characterized in that the ground connector comprises a sleeve-type connector body, that the at least one opening element is positioned at the inside of the connector body, and that the at least one opening element comprises a cutting edge or a needlepoint directed inwards in the radial direction of the connector body.

8. A method for earthing a cable having an outer jacket surrounding an inner conductor, wherein
a) a ground connector comprising a connector body, with at least one contact element for providing electrical contact between the connector body and the inner conductor of the cable and at least one opening element so designed to cut and/or perforate the outer jacket, is collocated over the outer jacket of the cable, and
b) the ground connector is activated by a rotational movement of the connector body and/or by applying a radial pressure to the connector body such that the at least one opening element cuts and/or perforates the outer jacket and the at least one contact element contacts the inner conductor.

9. The method according to claim 8 for use with ground connector comprising a sleeve-type connector body in which the at least one opening element comprises a blade inclined with respect to the radial direction of the connector body, characterized in that the ground connector is activated by rotating the connector body in the direction where the blade of the at least one opening element is pointing towards.

10. The method according to claim 8 for use with a ground connector comprising an annular connector body and an annular shell body surrounding the connector body; the shell body being twistable against the connector body and comprising at least one recess for housing at least one opening element in a radially outer position; the at least one opening element being movable in a radial direction, having an inclined outer face and having a cutting edge at its radially inner side, characterized in that the ground connector is activated by rotating the shell body against the connector body in the direction in which the stretch of the movable opening element in the radial direction increases.

11. The method according to claim 8 for use with a ground connector comprising a sleeve-type connector body in which the at least one opening element is positioned at the inside of the connector body, and the at least one opening element comprises a cutting edge or a needlepoint directed inwards in the radial direction of the connector body, characterized in that the ground connector is activated by applying radial pressure to the connector body, in particular by pressing together two tabs of the sleeve-type connector body.
